(19) United States
(12) Patent Application Publication
(10) Pub. No.: US 2021/0247100 A1
(43) Pub. Date: Aug. 12, 2021

(54) WATER HEATER

(71) Applicant: NORITZ CORPORATION, HYOGO (JP)

(72) Inventors: Takeshi Ohigashi, HYOGO (JP); Masaki Kondo, HYOGO (JP)

(73) Assignee: NORITZ CORPORATION, HYOGO (JP)

(21) Appl. No.: 17/054,770

(22) PCT Filed: Jun. 24, 2019
(86) PCT No.: PCT/JP2019/024955

§ 371 Date: Nov. 11, 2020

(30) Foreign Application Priority Data
Jul. 27, 2018 (JP) 2018-140960
Aug. 24, 2018 (JP) 2018-156970

(51) Int. Cl. F24H 1/10; F24H 8/00; F28F 1/32; F28F 9/00

(52) U.S. Cl. CPC F24H 1/107; F24H 8/00; F28F 2235/00; F28F 9/005; F28F 1/325

(57) ABSTRACT

A water heater (WH) comprises: a primary heat exchanger (H1) that recovers heat from heating gas; a secondary heat exchanger (H2); and a heating gas flow regulator (48, 40a) for regulating the flow of heating gas so that heating gas flowing inside a first case (2) of the primary heat exchanger (H1) in an area near at least one side wall part (20) of the first case (2) is prevented from entering designated gaps (C2, C3) in the secondary heat exchanger (H2). Thus, high temperatures in side wall parts (50) of the secondary heat exchanger (H2) can be suitably prevented and heating efficiency can be suitably improved.

### TECHNICAL FIELD

The present invention relates to a water heater such as a hot water supply device, and more specifically relates to a water heater of a type including a primary heat exchanger and a secondary heat exchanger.

### BACKGROUND ART

There is a water heater including, in addition to a primary heat exchanger for recovering sensible heat from combustion gas (heating gas), a secondary heat exchanger for further recovering latent heat from combustion gas after sensible heat is recovered by this primary heat exchanger. Here, each of the primary heat exchanger and the secondary heat exchanger has a configuration in which heat transfer pipes are accommodated inside each of cases thereof. Regarding heat transfer pipes of the secondary heat exchanger, for example, meandering pipes or U-shaped pipes having a non-straight pipe shape may be used (for example, Patent Literature 1).

However, in the foregoing technology in the related art, there is room for improvement as described below.

That is, in a configuration in which heat transfer pipes using meandering pipes or U-shaped pipes are accommodated inside a case of a secondary heat exchanger, a gap may be generated between the heat transfer pipes and a side wall part of the case. In this case, there is concern that a relatively large amount of combustion gas, of combustion gas which has passed through a primary heat exchanger, may enter the gap. Hence, an amount of heat recovered by the heat transfer pipes is reduced, and thus heating efficiency deteriorates. In addition, combustion gas which has entered the gap directly acts on the side wall part of the case, and thus a problem that the side wall part is heated to a high temperature is also caused.

### CITATION LIST

### Patent Literature

[Patent Literature 1]

Japanese Patent Laid-Open No. 2013-130348

[Patent Literature 2]

Japanese Patent Laid-Open No. H10-325610

[Patent Literature 3]

Japanese Patent Laid-Open No. H7-127911

### SUMMARY OF INVENTION

### Technical Problem

An object of the present invention is to provide a water heater capable of resolving the problems described above.

### Solution to Problem

In order to solve the foregoing problem, the following technical means is devised in the present invention.

According to the present invention, there is provided a water heater including a primary heat exchanger which has a first case having heating gas supplied to an inside thereof and is capable of recovering heat from the heating gas, a secondary heat exchanger in which a heat transfer pipe is accommodated inside a second case having heating gas that has passed through the primary heat exchanger flowing thereinto and a gap is formed between at least one side wall part of the second case and the heat transfer pipe, and heating gas flow regulator which regulate a flow of heating gas flowing in an area near at least one side wall part of the first case inside the first case such that the heating gas is inhibited from entering the gap in the secondary heat exchanger.

Preferably, the primary heat exchanger includes a plurality of plate-shaped fins arranged at intervals in a front-rear width direction of the first case. A flexural piece part that is bent or curved to the side wall part side of the first case is provided in an outermost end fin, of the plurality of fins, positioned at an outermost end part in the front-rear width direction. The heating gas flow regulator includes the flexural piece part.

Preferably, the flexural piece part has spring properties in the front-rear width direction by being bent or curved in a non-orthogonal shape from a main body part of the outermost end fin and abuts the side wall part of the first case with a repulsive force.

Preferably, the flexural piece part is provided at an end edge part of the outermost end fin on a downstream side in a heating gas flowing direction, and at least a distal end part of this flexural piece part is inclined or curved to an upstream side in the heating gas flowing direction.

Preferably, the water heater according to the present invention further includes a plurality of heat transfer pipes which serve as the heat transfer pipe, in which a plurality of straight pipe body parts arranged in an upward-downward height direction have a meandering shape or a U-shape and are connected in series with at least one connection pipe body part therebetween, and which are arranged in a lateral width direction of the second case. The gap is formed between the connection pipe body part and the side wall part of the second case.

Preferably, the heating gas flow regulator includes a guide part which is provided inside the first case, of which a first end part on an upstream side in a heating gas flowing direction comes into contact with or comes near the side wall part of the first case, and of which a second end part on a downstream side in the heating gas flowing direction is positioned nearer to a central part of the first case in a lateral width direction than the gap. The guide part is capable of guiding heating gas flowing in an area near the side wall part of the first case such that the heating gas flows to a central part side of the second case in the lateral width direction.

Preferably, the primary heat exchanger includes a plurality of plate-shaped fins arranged at intervals in a front-rear width direction of the first case. A bent piece part that is inclined in a manner of being positioned on the central part side of the first case toward the downstream side in the heating gas flowing direction is provided at an end edge part of each of the plurality of fins in the lateral width direction. The guide part includes the bent piece part.

Preferably, the water heater according to the present invention further includes a plurality of heat transfer pipes which serve as the heat transfer pipe, in which a plurality of straight pipe body parts arranged in an upward-downward height direction have a meandering shape or a U-shape and are connected in series with at least one connection pipe body part therebetween, and which are arranged in the lateral width direction. The gap is formed between a heat transfer pipe, of the plurality of heat transfer pipes, positioned at an end part in the lateral width direction and the side wall part of the second case.

Preferably, the water heater according to the present invention further includes a bent piece part which is provided at an end edge part in the lateral width direction of each of a plurality of intermediate fins, of the plurality of fins, as distinct from the outermost end fin, is inclined in a manner of being positioned on a central part side of the first case toward a downstream side in a heating gas flowing direction, and is capable of guiding heating gas flowing in an area near the side wall part of the first case such that the heating gas flows to a central part side of the second case in the lateral width direction. The heating gas flow regulator includes the bent piece part.

Other features and advantages of the present invention will become more apparent from the following description of embodiments of the invention performed with reference to the accompanying drawings.

### BRIEF DESCRIPTION OF DRAWINGS

FIG. 1 is a perspective view of a primary heat exchanger and a secondary heat exchanger constituting a water heater according to the present invention.

FIG. 2A is a cross-sectional view (a cross-sectional view along line IIA-IIA in FIG. 1) showing an example of a water heater configured to include the primary heat exchanger and the secondary heat exchanger shown in FIG. 1. FIG. 2B is an enlarged cross-sectional view of a main part in FIG. 2A.

FIG. 3 is a cross-sectional view of a main part at a place different from that in FIG. 2A in the water heater shown in FIG. 2A.

FIG. 4 is a perspective view of the secondary heat exchanger shown in FIGS. 1 and 2A.

FIG. 5A is a cross-sectional view along VA-VA in FIG. 2A. FIG. 5B is an enlarged view of a main part in FIG. 5A.

FIG. 6 is a perspective view of a main part of a fin shown in FIG. 5A.

FIG. 7 is a perspective view of an outermost end fin of the primary heat exchanger shown in FIGS. 1 to 3.

FIG. 8 is a cross-sectional view of a main part showing an example of a step of assembling a plurality of fins of the primary heat exchanger shown in FIGS. 1 to 3 to heat transfer pipes.

FIG. 9 is a cross-sectional view of a main part showing another embodiment of the present invention.

FIG. 10 is a front view showing another example of a second heat transfer pipe.

### DESCRIPTION OF EMBODIMENTS

Hereinafter, preferable embodiments of the present invention will be specifically described with reference to the drawings.

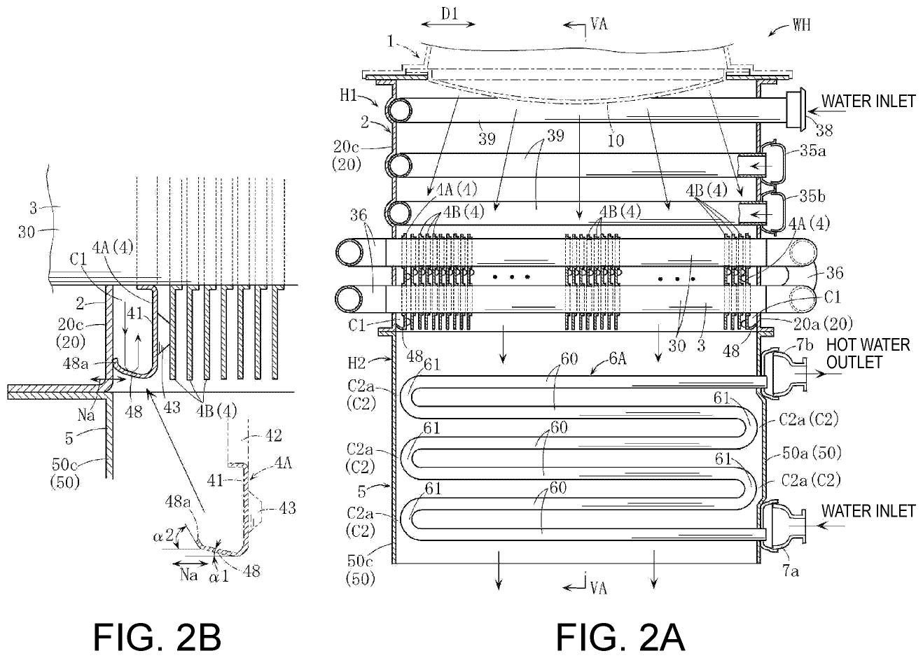

A water heater WH shown in FIG. 2A is equipped with a primary heat exchanger H1, a secondary heat exchanger H2, and a burner 1 which is partially indicated by the imaginary line. A member (not illustrated) for discharging combustion gas after heat recovery to the outside as exhaust gas is provided on a side below the secondary heat exchanger H2.

The burner 1 is a known reverse combustion-type gas burner in the related art. In this burner 1, an air-fuel mixture of combustion air discharged from a fan (not illustrated) and fuel gas is injected downward from above a first case 2 of the primary heat exchanger H1, passes through a combustion plate 10 having air permeability, and is supplied to the inside of the first case 2. The air-fuel mixture is subjected to ignition, and combustion gas as heating gas is supplied to the inside of the first case 2.

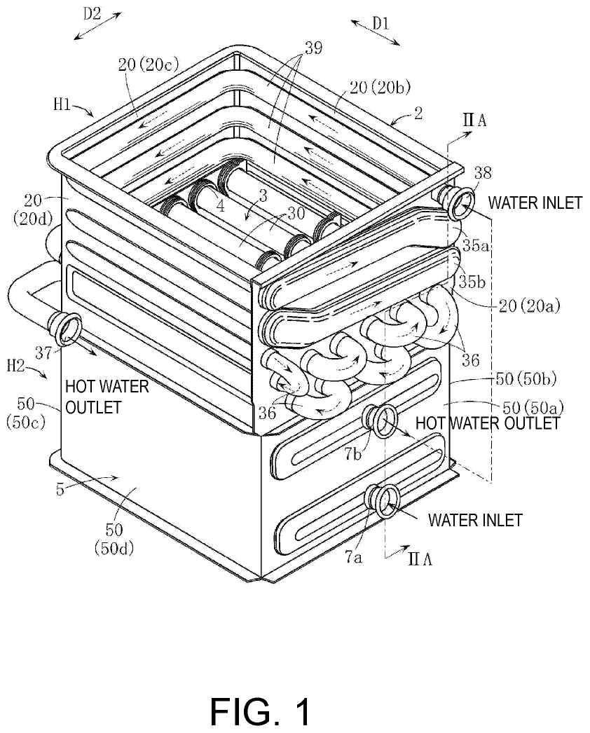

In addition to the first case 2 described above, the primary heat exchanger H1 includes heat transfer pipes 3, and a plurality of fins 4 (4A and 4B) for absorbing heat and a plurality of auxiliary pipes 39. The first case 2 has substantially a rectangular tube shape in which both upper and lower surfaces are open and has first to fourth side wall parts 20 (20a to 20d) as shown in FIG. 1. The auxiliary pipes 39 play a role of cooling the second to fourth side wall parts 20b to 20d of the first case 2 in addition to absorbing heat from combustion gas and have substantially a lying U-shape in a plan view provided along inner surfaces of the second to fourth side wall parts 20b to 20d. Header parts 35a and 35b for connecting the plurality of auxiliary pipes 39 in series are provided in the first side wall part 20a. The first side wall part 20a is cooled by water flowing inside the header parts 35a and 35b. Water which has been supplied through a water inlet port 38 of the auxiliary pipes 39 passes through the auxiliary pipes 39 and the header parts 35a and 35b along a path indicated by the dotted line arrows in FIG. 1 and thereafter flows into the heat transfer pipes 3. The heat transfer pipes 3 have a configuration in which a plurality of straight pipe body parts 30 lying transversely inside the first case 2 and arranged in a vertical direction and a horizontal direction are connected in series with a bent pipe 36 therebetween. Water which has flowed into the heat transfer pipes 3 from the auxiliary pipes 39 arrives at a water outlet port 37.

In FIG. 2A, the plurality of fins 4 have a plate shape penetrated by the straight pipe body parts 30 of the heat transfer pipes 3, are joined to the straight pipe body parts 30 using brazing means, and are arranged at intervals in a longitudinal direction (front-rear width direction D1 of the first case 2) of the straight pipe body parts 30. The plurality of fins 4 are divided into a pair of outermost end fins 4A positioned at both end parts in the front-rear width direction D1 and a plurality (a number) of intermediate fins 4B positioned between these pair of outermost end fins 4A. Specific configurations thereof will be described below.

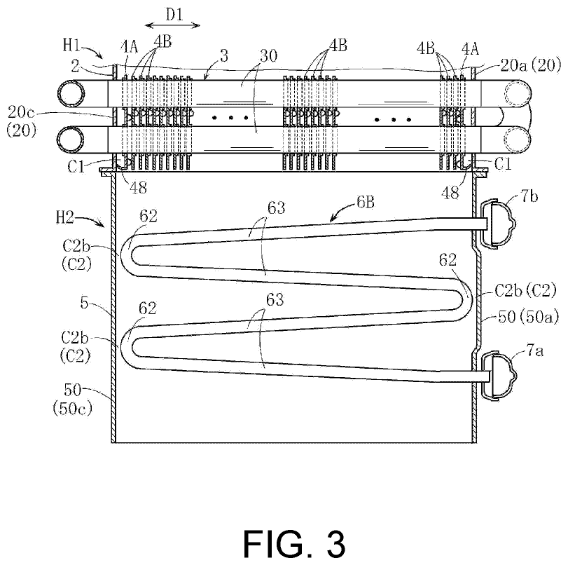

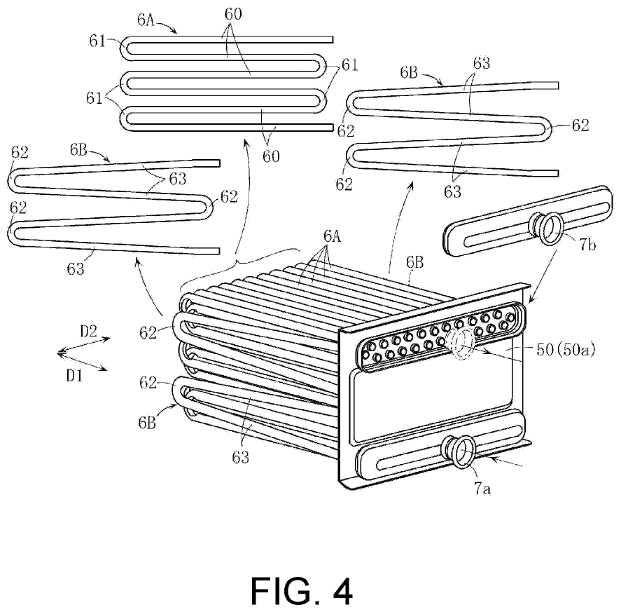

In FIGS. 2A and 3, the secondary heat exchanger H2 has a configuration in which first and second heat transfer pipes 6A and 6B serving as meandering-shaped heat transfer pipes are accommodated inside a second case 5 having substantially a rectangular tube shape of which both upper and lower surfaces are open. The second case 5 has first to fourth side wall parts 50 (50a to 50d). In FIGS. 2A and 4, the first heat transfer pipes 6A have a meandering shape in which a plurality of straight pipe body parts 60 arranged in an upward-downward height direction and extending in the horizontal direction are connected in series with a plurality of connection pipe body parts 61 having a semicircular arc shape in a side view therebetween. Both end parts of the first heat transfer pipes 6A are connected to water inputting/outputting headers 7a and 7b provided outside the second case 5.

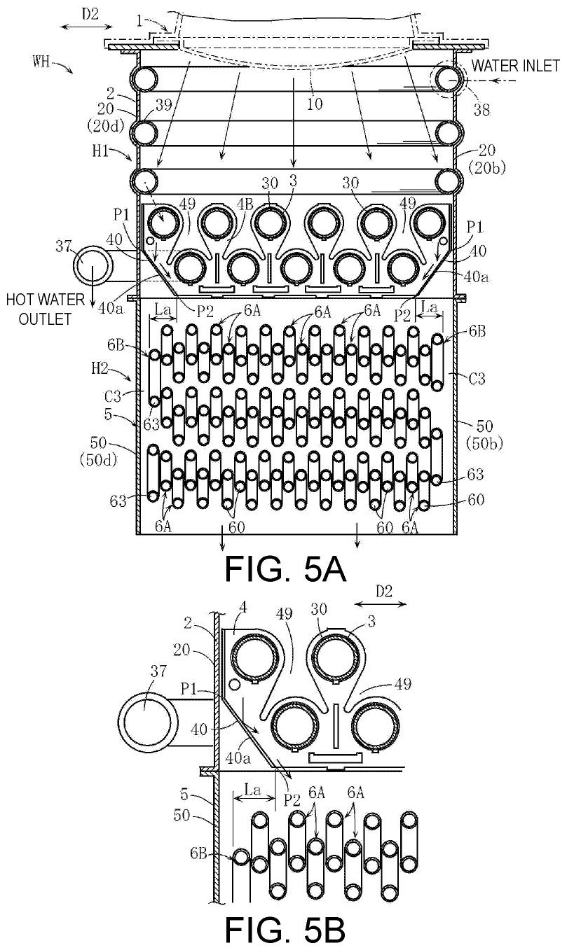

As shown in FIG. 5A, the plurality of first heat transfer pipes 6A are arranged at intervals in a lateral width direction D2. However, a vertical step is provided between the first heat transfer pipes 6A adjacent to each other, and the plurality of first heat transfer pipes 6A are arranged in a zig-zag manner.

In FIGS. 3 and 4, the second heat transfer pipes 6B have a meandering shape in which straight pipe body parts 63 arranged in the upward-downward height direction and vertically inclined are connected in series with a plurality of connection pipe body parts 62 having a semicircular arc shape in a side view therebetween. Similar to the first heat transfer pipes 6A, both end parts of the second heat transfer pipes 6B are connected to the water inputting/outputting headers 7a and 7b. Since each of straight pipe body parts 63 is vertically inclined, the second heat transfer pipes 6B have favorable drainage properties. Even if the inside of the first heat transfer pipes 6A freezes during a cold season, hot water can be supplied by circulating water in the second heat transfer pipes 6B.

As shown in FIGS. 4 and 5A, the second heat transfer pipes 6B are provided such that they are positioned on both left and right outer sides of the plurality of first heat transfer pipes 6A in the lateral width direction D2. Water which has been supplied to the header 7a passes through the first and second heat transfer pipes 6A and 6B, arrives at the header 7b, is supplied to the water inlet port 38 of the primary heat exchanger H1 thereafter, and is sent to the auxiliary pipes 39 and the heat transfer pipes 3. In such a process, water is heated by combustion gas.

In FIGS. 2A and 2B, a flexural piece part 48 for blocking a lower end opening part of a first gap C1 is provided in each of the pair of outermost end fins 4A. The first gap C1 is a gap between each of the first and third side wall parts 20a and 20c of the first case 2 and the outermost end fins 4A. The flexural piece parts 48 are portions (corresponding to an example of heating gas flow regulator referred to in the present invention) for regulating inflow of combustion gas to second gaps C2 (which will be described below) of the secondary heat exchanger H2 and are formed integrally with the outermost end fins 4A due to lower edge parts of the outermost end fins 4A which are bent to a side outward from the primary heat exchanger H1 in the front-rear width direction D1. As indicated by the imaginary line in FIG. 2B, the flexural piece parts 48 are bent or curved in a non-orthogonal shape inclined upward from main body parts 41 of the outermost end fins 4A in a natural state in which they are not accommodated inside the first case 2 and have spring properties in a direction indicated by the arrow Na. Distal end parts 48a of the flexural piece parts 48 are further bent or curved upward, and an inclined angle α2 thereof is larger than an inclined angle al of other parts of the flexural piece parts 48. As indicated by the solid line in FIG. 2B, the flexural piece parts 48 are positioned inside the first case 2 in a state of being compressed in the front-rear width direction D1 while the distal end parts 48a abut the first and third side wall parts 20 (20a and 20c) of the first case 2.

The outermost end fin 4A has a form as shown in FIG. 7, for example, and the flexural piece part 48 is provided in a connected manner substantially throughout the overall length area at a lower end part of the outermost end fin 4A. In addition, opening parts 42 for inserting heat transfer pipes, and a plurality of projected parts 43 are provided in the outermost end fin 4A. The plurality of projected parts 43 are portions for defining the dimensions between the intermediate fin 4B and the outermost end fin 4A by causing the outermost end fin 4A to abut the adjacent intermediate fin 4B as clearly shown in FIG. 2B.

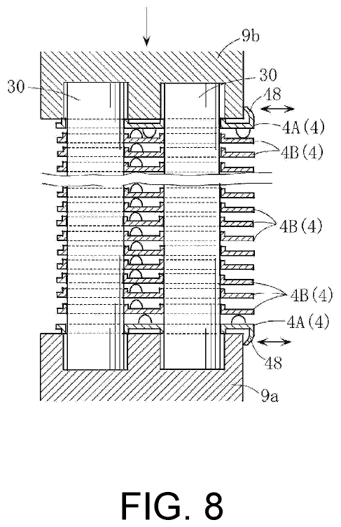

For example, work of assembling the plurality of fins 4 to the heat transfer pipes 3 is performed though a step as shown in FIG. 8. In the same diagram, in a state in which the straight pipe body parts 30 are held in a manner of standing upright on a lower jig 9a, the plurality of fins 4 are externally fitted to the straight pipe body parts 30, and they are press-fitted by an upper jig 9b and are placed such that arrangement pitches therebetween become straight. At this time, the flexural piece parts 48 of the outermost end fins 4A abut side surfaces of the lower and upper jigs 9a and 9b. Since the flexural piece parts 48 have spring properties as has already been described, such setting can be performed. Consequently, during work of assembling the plurality of fins 4, the flexural piece parts 48 can be prevented from being a hindrance.

As shown in FIGS. 2A and 3, the second gaps C2 (C2a and C2b) are formed inside the secondary heat exchanger H2. The second gaps C2a are formed between the first and third side wall parts 50 (50a and 50c) and the distal end parts of the connection pipe body parts 61. The second gaps C2b are formed between the first and third side wall parts 50 (50a and 50c) and the distal end parts of the connection pipe body parts 62. Both the second gaps C2a and C2b are positioned immediately below the first gaps C1.

As shown in FIG. 5A, third gaps C3 are also formed inside the secondary heat exchanger H2. These third gaps C3 are gaps formed between the second and fourth side wall parts 50 (50b and 50d) and the second heat transfer pipes 6B.

In the present embodiment, regarding means for regulating inflow of combustion gas into the third gaps C3, guide parts 40a (corresponding to another example of the heating gas flow regulator referred to in the present invention) formed in each of the plurality of intermediate fins 4B are provided.

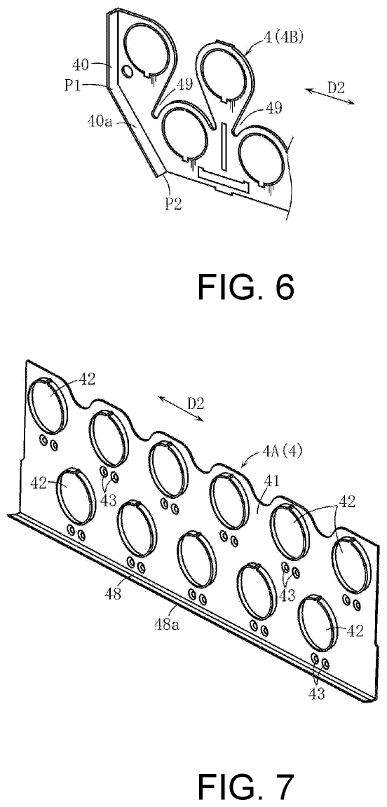

The intermediate fin 4B has a plate shape in which cutout parts 49, hole parts 48 for inserting heat transfer pipes, and the like are formed. At both end edge parts of the intermediate fin 4B in the lateral width direction D2, bent piece parts 40 realized by bending these end edge parts to the side in front of or behind the intermediate fin 4B are provided (also refer to FIG. 6). Areas near upper parts of these bent piece parts 40 come into contact with or come near the second and fourth side wall parts 20 (20b and 20d) of the first case 2 and extend in the upward-downward height direction. In contrast, areas near lower parts of the bent piece parts 40 are inclined in a manner of being positioned on a central part side of the first and second cases 2 and 5 in the lateral width direction D2 as they go downward and constitute the guide parts 40a for guiding combustion gas. First end parts P1 serving as upper end parts of these guide parts 40a come into contact with or come near the side wall parts 20 (20b and 20d), whereas second end parts P2 serving as lower end parts thereof are positioned on the central part side of the first and second cases 2 and 5 in the lateral width direction D2 by an adequate dimension La from the third gaps C3.

Next, actions of the foregoing water heater WH will be described.

First, in FIG. 2A, combustion gas supplied from the burner 1 to the primary heat exchanger H1 flows into the secondary heat exchanger H2 after heat recovery is completed by the auxiliary pipes 39 and the heat transfer pipes 3. Here, since parts, of the first and third side wall parts 50a and 50c of the second case 5, facing the second gaps C2a shown in FIG. 2A and the second gaps C2b shown in FIG. 3 are not cooled by the first and second heat transfer pipes 6A and 6B, when a large amount of combustion gas flows into the second gaps C2a and C2b, the temperature thereat is likely to be high.

In contrast, in the present embodiment, since the lower end opening parts of the first gaps C1 positioned immediately above the second gaps C2a and C2b are blocked by the flexural piece parts 48 of the outermost end fins 4A, it is difficult for combustion gas to pass through the first gaps C1 and flow into the second gaps C2a and C2b as it stands. Therefore, an inflow amount of combustion gas to the second gaps C2a and C2b is reduced, and an abnormally high temperature at the first and third side wall parts 50a and 50c is appropriately resolved. In addition, when a large amount of combustion gas travels to the second gaps C2a and C2b, heating efficiency deteriorates, but such a problem is also resolved.

As described with reference to FIG. 2B, the flexural piece parts 48 have spring properties and abut the side wall parts 20 (20a and 20c) with a repulsive force. For this reason, the flexural piece parts 48 can be in a state of stably abutting the side wall parts 20, and a relatively large gap causing leakage of combustion gas between the side wall parts 20 and the flexural piece parts 48 can be prevented from occurring. In addition, if the flexural piece parts 48 have a configuration having spring properties, when the plurality of fins 4 are disposed inside the first case 2 together with the straight pipe body parts 30 of the heat transfer pipes 3, for instance, even if there is a dimensional error to a certain degree in intervals between the pair of outermost end fins 4A, this error can be absorbed due to the foregoing spring properties, and each of the flexural piece parts 48 can be caused to appropriately abut the side wall parts 20.

Since the inclined angle α2 of the distal end parts 48a of the flexural piece parts 48 is set to be large, these distal end parts 48a and the side wall parts 20 (the side wall parts 20a and 20c) can be brought into surface contact with each other, and sealing properties therebetween can also be enhanced. Moreover, the flexural piece parts 48 are bent or curved obliquely upward from the lower ends of the outermost end fins 4A, and the bending direction or the curving direction thereof is a turning direction with respect to the main body parts 41 of the outermost end fins 4A. For this reason, when the plurality of fins 4 including the outermost end fins 4A are incorporated into the first case 2, the flexural piece parts 48 do not cause hooking, stretching, or the like with respect to the side wall parts 20 and can be inserted into the first case 2 in a sliding manner while the flexural piece parts 48 are smoothly subjected to compressive deformation.

On the other hand, in FIG. 5A, since the third gaps C3 are also present inside the second case 5, for instance, if a large amount of combustion gas flows into these third gaps C3, the temperature at places, of the second and fourth side wall parts 50b and 50d, facing the third gaps C3 are likely to be high. In addition, heating efficiency deteriorates. In contrast, the guide parts 40a of the intermediate fins 4B guide combustion gas traveling downward in areas near the second and fourth side wall parts 20b and 20d of the first case 2 such that the combustion gas moves forward to the central part side of the first and second cases 2 and 5 in the lateral width direction D2.

As it has already been described, the second end parts P2 of the guide parts 40a are positioned on the central part side with respect to the second heat transfer pipe 6B positioned on the outermost side in the secondary heat exchanger H2, and the positions immediately above the third gaps C3 have a positional relationship of being covered by the guide parts 40a. For this reason, when combustion gas is guided by the guide parts 40a and flows into the secondary heat exchanger H2, this combustion gas does not travel or scarcely travels toward the third gaps C3. Therefore, a problem caused by a large amount of combustion gas traveling to the third gaps C3, that is, heating of the second and fourth side wall parts 50b and 50d at an abnormally high temperature and deterioration in heating efficiency can also be prevented appropriately. Since the guide parts 40a are constituted utilizing the intermediate fins 4B, there is no need to provide a dedicated member therefor, and thus manufacturing costs can be reduced.

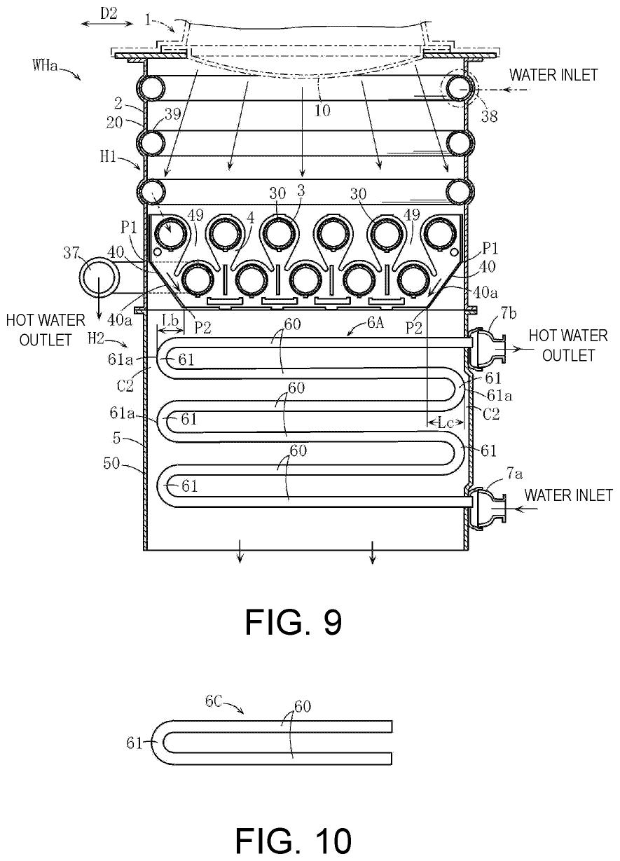

FIGS. 9 and 10 show another embodiment of the present invention. In these diagrams, the same reference signs as in the foregoing embodiment are applied to elements which are the same as or similar to those in the foregoing embodiment, and duplicate description will be omitted.

In a water heater WHa shown in FIG. 9, the direction of the secondary heat exchanger H2 is configured to be different from that in the foregoing embodiment by 90°. In the configuration thereof, heat transfer pipes 6A are shown as heat transfer pipes of the secondary heat exchanger H2, but the second heat transfer pipes 6B of the foregoing embodiment are not provided.

In the present embodiment, for example, each of distal end parts 61a of the connection pipe body parts 61 of the heat transfer pipes 6A is positioned on the outermost side in the lateral width direction D2, and the second gaps C2 are formed between the distal end parts 61a and the side wall parts 50. In contrast, the second end parts P2 of the guide parts 40a are positioned on the central part side in the lateral width direction D2 from the foregoing distal end parts 61a by adequate dimensions Lb and Lc.

According to such a configuration, a large amount of combustion gas flowing into the secondary heat exchanger H2 from the primary heat exchanger H1 is appropriately prevented from entering the second gaps C2. Therefore, better heating efficiency can be achieved, and the problem that the side wall parts 50 of the case 5 are heated to a high temperature can be appropriately prevented.

FIG. 10 shows another example of a heat transfer pipe used in the secondary heat exchanger H2. A heat transfer pipe 6C shown in the same diagram has a U-shape having two straight pipe body parts 60 and one connection pipe body part 61. In the present invention, in place of a meandering-shaped heat transfer pipe, a U-shaped heat transfer pipe 6C can also be used.

The present invention is not limited to the details of the embodiments described above. The specific configuration of each part in the water heater according to the present invention can be subjected to various design changes within a range intended by the present invention.

Preferably, the flexural piece parts 48 of the outermost end fins 4A are provided such that they abut the side wall parts 20 of the first case 2 and opening parts of the first gaps C1 are fully closed, but the present invention is not limited thereto. The flexural piece parts 48 need only be bent or curved to the side wall parts 20 side of the first case 2 such that heating gas flowing from the first gaps C1 toward the second gaps C2 can be regulated (prevented or curbed). The flexural piece parts 48 and the side wall parts 20 may be separated from each other. Also in such a configuration, the inflow amount of heating gas to the second gaps C2 can be reduced.

It is usual that the outermost end fins 4A are present in a form of a pair on the left and right sides, and it is preferable that the flexural piece parts 48 be provided in each of the pair of outermost end fins 4A, but the present invention is not limited thereto. For example, a configuration in which the flexural piece parts 48 are provided in only one of the pair of outermost end fins 4A is also included in the technical scope of the present invention.

In the embodiments described above, two kinds of means such as the flexural piece parts 48 and the guide parts 40a are provided as heating gas flow regulator, but a configuration in which only one of is provided may be adopted.

The water heaters of the embodiments described above are reverse combustion-type water heaters in which a burner is disposed on the side above primary and secondary heat exchangers, and the flowing direction of heating gas (combustion gas) is directed downward, but the present invention is not limited thereto. For example, a normal combustion type in which a burner is disposed on the side below primary and secondary heat exchangers and the flowing direction of heating gas (combustion gas) is directed upward can also be adopted.

Heating gas is not limited to combustion gas. For example, high-temperature exhaust gas generated in a cogeneration system can also be used as heating gas.

The water heater referred to in the present invention has a function of generating hot water by heating water and includes a hot water supply device for bath, a water heater for heating, and a water heater for snow melting, for example, in addition to a general hot water supply device.

Regarding heat transfer pipes of a secondary heat exchanger, heat transfer pipe having a shape other than a meandering shape or a U-shape can also be used.

1. A water heater comprising:
a primary heat exchanger which has a first case having heating gas supplied to an inside thereof and is capable of recovering heat from the heating gas;
a secondary heat exchanger in which a heat transfer pipe is accommodated inside a second case having heating gas that has passed through the primary heat exchanger flowing thereinto and a gap is formed between at least one side wall part of the second case and the heat transfer pipe; and
heating gas flow regulator which regulates a flow of heating gas flowing in an area near at least one side wall part of the first case inside the first case such that the heating gas is inhibited from entering the gap in the secondary heat exchanger.

2. The water heater according to claim 1,
wherein the primary heat exchanger includes a plurality of plate-shaped fins arranged at intervals in a front-rear width direction of the first case,
wherein a flexural piece part that is bent or curved to the side wall part side of the first case is provided in an outermost end fin, of the plurality of fins, positioned at an outermost end part in the front-rear width direction, and
wherein the heating gas flow regulator includes the flexural piece part.

3. The water heater according to claim 2,
wherein the flexural piece part has spring properties in the front-rear width direction by being bent or curved in a non-orthogonal shape from a main body part of the outermost end fin and abuts the side wall part of the first case with a repulsive force.

4. The water heater according to claim 2,
wherein the flexural piece part is provided at an end edge part of the outermost end fin on a downstream side in a heating gas flowing direction, and at least a distal end part of the flexural piece part is inclined or curved to an upstream side in the heating gas flowing direction.

5. The water heater according to claim 2, further comprising:
a plurality of heat transfer pipes which serve as the heat transfer pipe, in which a plurality of straight pipe body parts arranged in an upward-downward height direction have a meandering shape or a U-shape and are connected in series with at least one connection pipe body part therebetween, and which are arranged in a lateral width direction of the second case,
wherein the gap is formed between the connection pipe body part and the side wall part of the second case.

6. The water heater according to claim 1,
wherein the heating gas flow regulator includes a guide part which is provided inside the first case, of which a first end part on an upstream side in a heating gas flowing direction comes into contact with or comes near the side wall part of the first case, and of which a second end part on a downstream side in the heating gas flowing direction is positioned nearer to a central part of the first case in a lateral width direction than the gap, and
wherein the guide part is capable of guiding heating gas flowing in an area near the side wall part of the first case such that the heating gas flows to a central part side of the second case in the lateral width direction.

7. The water heater according to claim 6,
wherein the primary heat exchanger includes a plurality of plate-shaped fins arranged at intervals in a front-rear width direction of the first case,
wherein a bent piece part that is inclined in a manner of being positioned on the central part side of the first case toward the downstream side in the heating gas flowing direction is provided at an end edge part of each of the plurality of fins in the lateral width direction, and
wherein the guide part includes the bent piece part.

8. The water heater according to claim 6, further comprising:
a plurality of heat transfer pipes which serve as the heat transfer pipe, in which a plurality of straight pipe body parts arranged in an upward-downward height direction have a meandering shape or a U-shape and are connected in series with at least one connection pipe body part therebetween, and which are arranged in the lateral width direction, and
wherein the gap is formed between a heat transfer pipe, of the plurality of heat transfer pipes, positioned at an end part in the lateral width direction and the side wall part of the second case.

9. The water heater according to claim 2, further comprising:
a bent piece part which is provided at an end edge part in a lateral width direction of each of a plurality of intermediate fins, of the plurality of fins, as distinct from the outermost end fin, is inclined in a manner of being positioned on a central part side of the first case toward a downstream side in a heating gas flowing direction, and is capable of guiding heating gas flowing in an area near the side wall part of the first case such that the heating gas flows to a central part side of the second case in the lateral width direction, and
wherein the heating gas flow regulator includes the bent piece part.
